(19) United States
(12) Patent Application Publication
(10) Pub. No.: US 2008/0146045 A1
(43) Pub. Date: Jun. 19, 2008

(54) Electrical connector assembly with protecting

(75) Inventor: Chun-Yi Chang, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/002,744

(22) Filed: Dec. 18, 2007

(30) Foreign Application Priority Data
Dec. 18, 2006 (CN) 200610166438.2

(51) Int. Cl. H01R 12/14

(52) U.S. Cl. 439/41; 439/76.1

(57) ABSTRACT

An electrical connector assembly (1) comprises an insulative housing (2) having opposite upper and lower surfaces, a plurality of contacts received in the insulative housing, and a protecting member (4) comprising opposite upper and lower plates (42, 44) parallel to each other and at least one connecting section (431, 432, 433) connecting the upper and lower plates. The upper and lower plates define a receiving space (40) therebetween and an opening (400) communicating with the receiving space and outside. The insulative housing is slidrably inserted into the receiving space of the protecting member from the opening and received in the receiving space of the protecting member with the upper and lower surfaces thereof are covered by the upper and lower plates of the protecting member.

### CROSS-REFERENCE TO RELATED APPLICATIONS

This application is related to U.S. patent application entitled “ELECTRICAL CONNECTOR ASSEMBLY WITH IMPROVED PICK UP CAP”, which has the same assignee as the present invention.

### BACKGROUND OF THE INVENTION

1. Field of the Invention

The present invention generally relates to an electrical connector assembly, and more particularly to an electrical connector assembly for removably mounting a chip module, such as a Central Processing Unit (CPU), to a printed circuit board.

2. Description of Related Art

U.S. Pat. No. 6,875,022, issued on Apr. 5, 2005 and U.S. Pat. No. 6,905,353, both assigned to HonHai, disclose an electrical connector assembly for electrically connecting a chip module to a printed circuit board. The electrical connector assembly comprises an insulative housing, a plurality of contacts received in the insulative housing, and a pick-up cap covering an upper surface of the insulative housing. The insulative housing defines a plurality of contact-receiving slots penetrating through upper and lower surfaces thereof. The contacts are received in the contact-receiving slots and have upper and lower contacting surfaces. The insulative housing is displaced on the printed circuit board to form electrical connection between the lower contacting surfaces of the contacts with the printed circuit board. Then the chip module is placed on the upper surface of the insulative housing to form electrical connection with the upper contacting surfaces of the contacts. Thus, the electrical connection between the chip module and the printed circuit board is realized.

The pick-up cap is latchably assembled to the upper surface of the insulative housing. The pick-up cap can be sucked by a vacuum mechanism to realize the movement of the electrical connector and covers the upper surface of the insulative housing to prevent dust from outside or damage made to upper contacting surfaces of the contacts. However, the electrical connector assembly with such structure has the shortcomings as follows: The pick-up cap only covers the upper surface of the insulative housing to protect the upper contacting surfaces of the contacts. The lower contacting surfaces of the contacts are not protected which are prone to be damaged or dusted during the movement of the insulative housing and the contacts.

Therefore, it is desired to provide an improved electrical connector assembly to stress the problems mentioned above.

### BRIEF SUMMARY OF THE INVENTION

Accordingly, an object of the present invention is to provide an electrical connector assembly with improved structure for providing complete protection to contacts thereof.

In order to achieve the above-mentioned object, an electrical connector assembly comprises an insulative housing having opposite upper and lower surfaces, a plurality of contacts received in the insulative housing, and a protecting member comprising opposite upper and lower plates parallel to each other and at least one connecting section connecting the upper and lower plates. The upper and lower plates define a receiving space therebetween and an opening communicating with the receiving space and outside. The insulative housing is slidrably inserted into the receiving space of the protecting member from the opening and received in the receiving space of the protecting member with the upper and lower surfaces thereof are covered by the upper and lower plates of the protecting member.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of an electrical connector assembly in accordance with the preferred embodiment of the present invention;

FIG. 2 is a partially assembled view of FIG. 1;

FIG. 3 is an assembled, perspective view of the electrical connector assembly of FIG. 1;

FIG. 4 is a cross-section view taken along line 4-4 of FIG. 3; and

FIG. 5 is a perspective view of a protecting member in accordance with another embodiment of the present invention.

### DETAILED DESCRIPTION OF THE INVENTION

Reference will now be made to the drawing figures to describe the present invention in detail.

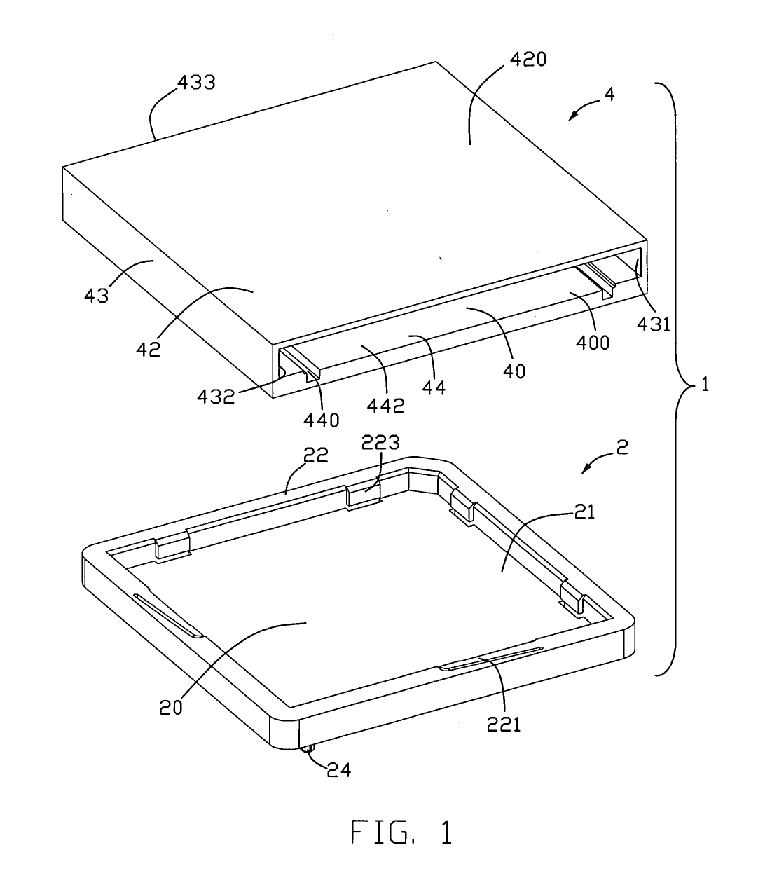

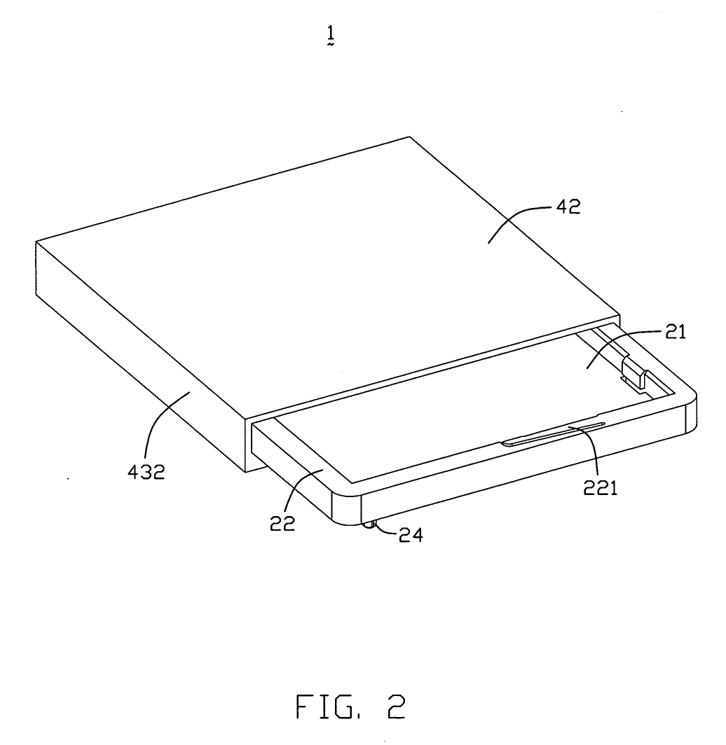

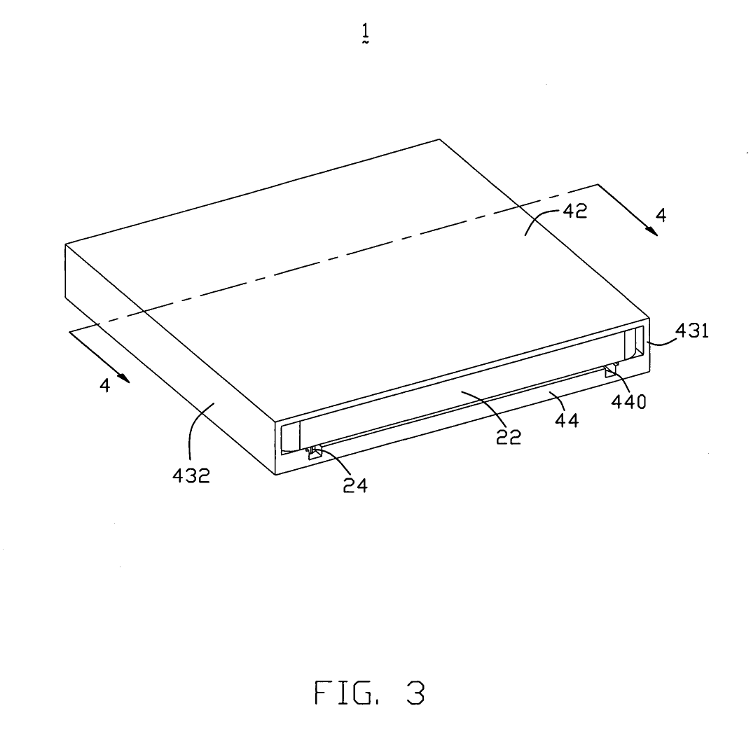

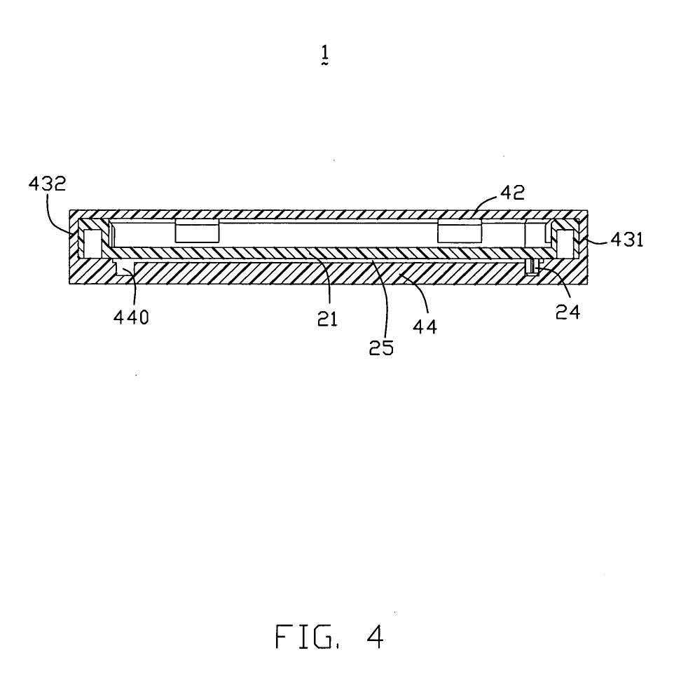

Please refer to FIGS. 1-4, an electrical connector assembly 1 in accordance with the preferred embodiment of the present invention is for electrically connecting a chip module (not shown), such as a Central Processing Unit (CPU), with a printed circuit board (PCB, not shown). The electrical connector assembly I comprises an insulative housing 2, a plurality of contacts (not shown) accommodated in the insulative housing 2, and a protecting member 4 removably assembled to the insulative housing 2. In the preferred embodiment of the present invention, the electrical connector is a Land Grid Array connector.

The insulative housing 2 is substantially rectangular and comprises a main portion 21 and four sidewalls 22 extending upwardly from the main portion 21. A receiving space 20 is circumscribed by the main potion 21 and the sidewalls 22 for accommodating the chip module. A plurality of contact-receiving passages (not shown) are defined through upper and lower surfaces of the main portion 21 to receive the contacts therein. Two adjacent sidewalls 22 form a pair of spring arms 221 splitting therefrom to face the receiving space 20 for elastically abutting against the chip module. The other two sidewalls 22 each forms a pair of projections 223 aligning with each other to serve as a datum for the chip module. At least a pair of posts 24 depend downwardly from the lower surface of the insulative housing 2 for positioning the insulative housing 2 relative to the printed circuit board. The posts 24 can be parts of the insulative housing 2 and formed integrally with the insulative housing 2 or separate members assembled to the insulative housing 2. Usually, the posts 24 are arranged along a diagonal line of the insulative housing 2.

Each contact comprises upper and lower contacting surfaces (not shown) respectively exposed beyond upper and lower surfaces of the insulative housing 2.

The protecting member 4 is a rectangular frame defining a rectangular receiving passage 40 corresponding to outer periphery of the insulative housing 2 with a front opening 400 communicating with outside. The receiving passage 40 is defined by upper plate 42 covering upper surface of the insulative housing 2, opposite lower plate 44 covering lower surface of the insulative housing 2 and thicker than the upper plate 42, opposite vertical first and second connecting sections 431, 432 connecting with the upper and lower plates 42, 44 and a rear third connecting section 433′ connecting with the upper and lower plates 42, 44 and the first and second connecting sections 431, 432 to seal the receiving passage 40. The first, second and third connecting sections 431, 432, 433 are all located in vertical planes and form a connecting portion 43. The front opening 400 is circumscribed by the upper and lower plates 42, 44 and the first and second connecting sections 431, 432. The upper surface 442 of the lower plate 44 is slotted with a pair of guiding slots 440 at opposite lateral sides thereof to permit the posts 24 of the insulative housing 2 to slide along the guiding slots 440 for facilitating the insertion of the insulative housing 2 into the protecting member 4. The upper surface 420 of the upper plate 42 is smooth for being sucked by a vacuum suction device (not shown). In the preferred embodiment of the present invention, the upper and lower plates 42, 44 and the connecting portion 43 are molded integrally. However, in an alternative embodiment, the members 42, 43, 44 also can be molded respectively and assembled to one another to form the receiving passage 40.

In assembly, the insulative housing 2 with the contacts 2 assembled therewith is inserted into the receiving passage 40 of the protecting member 4 from the opening 400. The posts 24 are inserted into and slide along the guiding slots 440 until one sidewall 22 of the insulative housing 2 abuts against the inner surface of the third connecting section 433. Thus, the upper surface of the insulative housing 2 is covered by and contacts the upper plate 42, and the outer surfaces of three sidewalls 22 contact the first, second and third connecting sections 431, 432, 433 with the other one sidewall 22 exposed outside from the opening 400. While, the lower surface of the insulative housing 2 is parallel to the inner surface 442 of the lower plate 44 with a first distance therebetween to form a lower receiving space 25 for accommodating the exposed lower contacting surfaces of the contacts. The receiving space 20 of the insulative housing 2 is sealed by the upper plate 42 of the protecting member 4 with the upper contacting surfaces of the contacts are exposed therein. Therefore, upper and lower contacting surfaces of the contacts are protected by the upper and lower plates 42, 44 of the protecting member 4 from being dusted and damaged from outside.

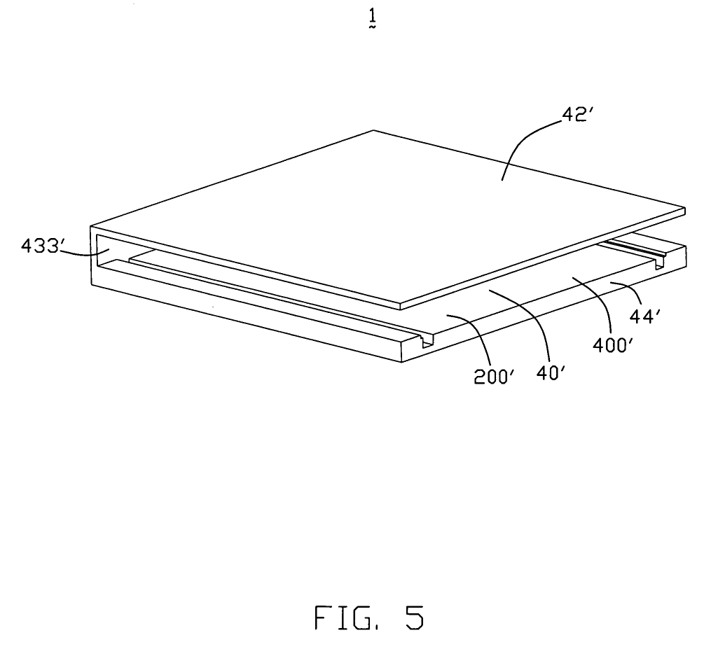

Please refer to FIG. 5, another protecting member 4′ in accordance with another embodiment of the present invention is illustrated. The protecting member 4′ is of inverted U-shape and comprises opposite upper and lower plates 42′, 44′ and a connecting section 433′ corresponding to the third connecting section 433 of the first embodiment connecting rear edges of the upper and lower plates 42′, 44′. However, the only one connecting section 433′ also can be arranged to connect side edges of the upper and lower plates 42′, 44′. That is, the connecting section 433′ may face the opening 400′ or does not face the opening 400′. Of course, a pair of connecting sections also can be arranged to connect the upper and lower plates 42′, 44′ which does not breach the spirit of the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
an insulative housing having opposite upper and lower surfaces; and
a plurality of contacts received in the insulative housing; and
a protecting member comprising opposite upper and lower plates parallel to each other and at least one connecting section connecting the upper and lower plates, the upper and lower plates defining a receiving space therebetween and an opening communicating with the receiving space and outside; wherein
the insulative housing is slidably inserted into the receiving space of the protecting member from the opening and received in the receiving space of the protecting member with the upper and lower surfaces thereof are covered by the upper and lower plates of the protecting member.

2. The electrical connector assembly as claimed in claim 1, wherein insulative housing forms a base portion and four sidewalls extending upwardly from the base portion, the contacts are partially exposed beyond upper and lower surfaces of the base portion of the insulative housing to form upper and lower exposed sections, and wherein the upper and lower exposed sections of the contacts are protected by the upper and lower plates of the protecting member.

3. The electrical connector assembly as claimed in claim 1, wherein the upper plate of the protecting member contacts the upper surface of the insulative housing, and wherein the lower plate of the protecting member is parallel arranged with the lower surface to form a lower receiving space.

4. The electrical connector assembly as claimed in claim 1, further comprising a pair of posts depending downwardly from the lower surface of the insulative housing, wherein the lower plate of the protecting member defines a pair of slots to permit the posts slide therealong for assembling the insulative housing into the receiving space of the protecting member.

5. The electrical connector assembly as claimed in claim 4, wherein the posts are arranged on the lower surface of the insulative housing along diagonal direction of the insulative housing.

6. The electrical connector assembly as claimed in claim 1, wherein the protecting member further comprises a second connecting section and a third connecting section each connecting with the upper and lower plates and said connecting section, and wherein the receiving space is defined by the upper and lower plates, the connecting section and the second and third connecting sections.

7. The electrical connector assembly as claimed in claim 6, wherein the opening is defined by the upper and lower plates and two of the connecting sections.

8. The electrical connector assembly as claimed in claim 6, wherein the insulative housing comprises a base portion and four sidewalls, and wherein three sidewalls of the insulative housing contacts the three connecting sections of the protecting member and the other one sidewall is exposed outside from the opening.

9. A Land Grid Array connector assembly adapted for electrically connecting a CPU with a printed circuit board (PCB), comprising:
an insulative housing having upper and lower surfaces, defining a plurality of contact-receiving passages, the insulative housing forming at least one post depending from at least one of the upper and lower surfaces thereof;
a plurality of contacts accommodated in the contact-receiving passages of the insulative housing and forming upper and lower contacting sections; and
a protecting member comprising opposite upper and lower plates and at least one connecting section connecting the upper and lower plates, the protecting member defining a receiving space between the upper and lower plates and at least one slot in at least one of the upper and lower plates; wherein
the insulative housing is slidrably received into the receiving space of the protecting member with the at least one of post thereof sliding along at least one slot of the protecting member.

10. The Land Grid Array connector assembly as claimed in claim 9, wherein the insulative housing forms a pair of posts depending downwardly from the lower surface thereof, and wherein the protecting member defines a pair of slots in the lower plate thereof to permit the slide of the posts.

11. The Land Grid Array connector assembly as claimed in claim 9, wherein the insulative housing comprises a base portion and four sidewalls extending upwardly from the base portion, wherein the upper plate contacts the upper surfaces of the sidewalls to form a close space together with the sidewalls an the base portion, and wherein the upper contacting sections of the contacts are exposed in the close space.

12. The Land Grid Array connector assembly as claimed in claim 11, wherein lower plate of the protecting member is parallel arranged with the lower surface of the base portion to form a lower close space, and wherein the lower contacting sections of the contacts are exposed in the lower close space.

13. The Land Grid Array connector assembly as claimed in claim 9, wherein the upper surface of the upper plate of the protecting member is smooth and is capable of being sucked by a vacuum suction mechanism.

14. The Land Grid Array connector assembly as claimed in claim 9, wherein the insulative housing forms a base portion and four sidewalls which together circumscribe a receiving space for accommodating the CPU, and wherein each of two sidewalls is formed with at least a spring arm facing the receiving space.

15. The Land Grid Array connector assembly as claimed in claim 14, wherein each of the other two sidewalls forms a pair of projections into the receiving space, and wherein the pair of projections are coplanar with each other.

16. An electrical connector assembly comprising:
an insulative housing having opposite upper and lower surfaces; and
a plurality of contacts received in the insulative housing; and
a protecting member comprising opposite upper and lower plates parallel to each other and commonly defining a receiving space therebetween, and an opening communicating the receiving space with an exterior in a transverse direction; wherein
the insulative housing is slidably inserted into the receiving space of the protecting member from the opening and received in the receiving space of the protecting member with the upper and lower surfaces thereof are covered by the upper and lower plates of the protecting member; wherein
a protrusion formed on the lower surface extends below a top face of the lower plate.

17. The electrical connector assembly as claimed in claim 16, wherein said protrusion performs a guiding function during insertion of the housing into the receiving space.
